(19) United States
(12) Patent Application Publication
(10) Pub. No.: US 2011/0197633 A1
(43) Pub. Date: Aug. 18, 2011

(54) METHOD FOR MANUFACTURING GLASS FILM

(76) Inventors: Masahiro TOMAMOTO, Otsu-shi (JP); Hidetaka Oda, Otsu-shi (JP); Shinichi Ishibashi, Otsu-shi (JP); Tatsuya Takaya, Otsu-shi (JP); Katsutoshi Fujiwara, Otsu-shi (JP)

(21) Appl. No.: 13/010,099

(22) Filed: Jan. 20, 2011

(30) Foreign Application Priority Data
Feb. 12, 2010 (JP) 2010-028524

(51) Int. Cl. C03B 17/06

(52) U.S. Cl. 65/94; 65/98

(57) ABSTRACT

Provided is a method, including: a melting step of melting glass in a melting furnace 2; a distribution step of supplying the molten glass in the melting furnace 2 to a plurality of branched channels 4; and a forming step of supplying the molten glass flowing out from each of the plurality of branched channels 4 to one of a plurality of forming apparatuses 51 to 53 communicating with the plurality of branched channels 4, respectively, and forming the molten glass into a plate-shaped glass by a down-draw method, in which one or more of the plurality of forming apparatuses 51 to 53 are used to form a glass film having a thickness of 1 to 200 μm.

### TECHNICAL FIELD

The present invention relates to a method for manufacturing a glass film which is used for a flat panel display, a solar cell, an OLED lighting device, or the like.

### BACKGROUND ART

In view of space saving, in recent years, there has been widely used a flat panel display, such as a liquid crystal display, a plasma display, an OLED display, or a field emission display, in place of CRT. Such flat panel display has been required to be further thinned. In particular, the OLED display is required to allow easy carrying by being folded or wound, and to allow attachment not only on a flat surface but also on a curved surface.

Further, not only is the display required to allow attachment on a curved surface, but it is also desired to form a solar cell or an OLED lighting device, for example, on a surface of a product having a curved surface, such as a surface of a vehicle body of an automobile or a roof, a pillar, or an outer wall of a building.

Therefore, various glass substrates including the flat panel display are required to be further thinned for satisfying a demand for flexibility high enough to deal with a curved surface. As disclosed, for example, in Patent Literature 1, a film-like thin plate glass having a thickness of 200 μm or less, i.e., the so-called glass film has been developed by a down-draw method.

### CITATION LIST

### Patent Literature

Patent Literature 1: JP 2008-133174 A

### SUMMARY OF INVENTION

### Technical Problem

By the way, in the case where a glass film is formed by a down-draw method, it is difficult to manufacture a glass film having a predetermined size stably. That is, the case of the glass film has a problem in that a slight variation of the flow rate of molten glass causes a change in the thickness of the glass film and uneven thickness of the glass film, and hence a high-precision glass film cannot be formed stably. Further, when the glass film formed is continuously wound and packaged, if the thickness of the glass film is non-uniform or uneven, an unnecessary stress is applied to the glass film while and after the glass film is wound, causing breakage of the glass film in some cases.

That is, for example, when a glass substrate for a liquid crystal display is manufactured, the thickness of the glass substrate is generally 0.7 mm, and it is necessary to significantly decrease the flow rate of molten glass flowing out from a melting furnace in the case where a glass film having a thickness of 1 to 200 μm is manufactured by a down-draw method, compared with the case where the glass substrate having a thickness of 0.7 mm is manufactured. However, in general, when blending conditions in and operational conditions of a melting furnace vary and the liquid level of molten glass rises and lowers, the flow rate of molten glass flowing into forming apparatuses tends to vary. The variation of the flow rate of molten glass is liable to affect the thickness and uneven thickness of the plate glass, and hence, as the thickness of the plate glass becomes smaller, the degree of variation of the thickness and the degree of uneven thickness become larger. Thus, when molten glass was supplied from a melting furnace to forming apparatuses and a glass film was formed by a down-draw method, the variation of the flow rate of the molten glass flowing into the forming apparatuses was liable to cause a change in the thickness of the resultant glass film and uneven thickness of the resultant glass film to a large extent. As a result, it was difficult to increase the productivity of the glass film.

The present invention has been made in consideration of the above-mentioned circumstances. A technical object of the present invention is to suppress the variation of the flow rate of molten glass flowing to forming apparatuses in the glass film forming, thereby suppressing a change in the thickness of the glass film and the occurrence of uneven thickness of the glass film.

### Solution to Problem

The inventors of the present invention have made intensive studies in order to solve the above-mentioned technical problem. As a result, the inventors have found that by distributing molten glass in a melting furnace separately to a plurality of branched channels, the variation of the flow rate of the molten glass flowing from the branched channels to respective forming apparatuses is suppressed, thereby being able to manufacture a glass film stably. Consequently, the present invention has been proposed.

That is, the invention according to claim 1, which has been made to solve the above-mentioned problem, relates to a method for manufacturing a glass film, including: a melting step of melting glass in a melting furnace; a distribution step of supplying the molten glass in the melting furnace to a plurality of branched channels; and a forming step of supplying the molten glass flowing out from each of the plurality of branched channels to one of a plurality of forming apparatuses communicating with the plurality of branched channels, respectively, and forming the molten glass into a plate-shaped glass by a down-draw method, in which one or more of the plurality of forming apparatuses are used to form a glass film having a thickness of 1 to 200 μm.

The invention according to claim 2, which has been made to solve the above-mentioned problem, relates to the method for manufacturing a glass film according to claim 1, in which a forming apparatus other than a forming apparatus for forming a glass film is used to form a plate glass having a thickness of more than 200 μm.

The invention according to claim 3, which has been made to solve the above-mentioned problem, relates to the method for manufacturing a glass film according to claim 1 or 2, in which the molten glass flowing in each of the plurality of branched channels is imparted with flow resistance.

The invention according to claim 4, which has been made to solve the above-mentioned problem, relates to the method for manufacturing a glass film according to any one of claims 1 to 3, in which the glass film is wound in a roll shape.

The invention according to claim 5, which has been made to solve the above-mentioned problem, relates to the method for producing a glass film according to any one of claims 1 to 4, in which the down-draw method includes an overflow down-draw method or a slot down-draw method.

### Advantageous Effects of Invention

According to the above-mentioned invention of claim 1, the method includes the melting step of melting glass in the melting furnace, the distribution step of supplying the molten glass in the melting furnace to the plurality of branched channels, and the forming step of supplying the molten glass flowing out from each of the plurality of branched channels to one of the plurality of forming apparatuses communicating with the branched channels, respectively, and forming the molten glass into a plate-shaped glass by the down-draw method, in which the one or more of the plurality of forming apparatuses are used to form the glass film having a thickness of 1 to 200 μm. As a result, the molten glass in the melting furnace flows through the plurality of distribution channels, and hence the flow rate of the molten glass delivered to each of the forming apparatuses for forming the glass film is stabilized.

That is, the method includes the plurality of distribution channels, and hence a large melting furnace can be introduced. As a result, the variation of the liquid level in the melting furnace can be suppressed. Further, the molten glass is delivered from the melting furnace to the plurality of forming apparatuses via the plurality of distribution channels, even if the liquid level of the molten glass rises and lowers depending on blending conditions in and operational conditions of the melting furnace, and hence the variation of the flow rate of the molten glass is reduced and adjusted through the plurality of distribution channels. As a result, the flow rate of the molten glass flowing into each forming apparatus for forming a glass film is stabilized, and the variation of the thickness of the glass film and the occurrence of uneven thickness of the glass film can be suppressed.

According to the invention of claim 2, the forming apparatus other than the forming apparatus for forming a glass film is used to form the plate glass having a thickness of more than 200 μm. Thus, the variation of the flow rate of the molten glass flowing from the melting furnace is easily reduced and adjusted through the branched channels each communicating with each forming apparatus for forming the plate glass having a thickness of more than 200 μm, even if the liquid level of the molten glass rises and lowers depending on operational conditions of the melting furnace. Thus, the flow rate of the molten glass flowing into the forming apparatus for forming a glass film is more stabilized, and the variation of the thickness of the glass film and the occurrence of uneven thickness of the glass film can be suppressed to the minimum level. Here, as the glass film has a smaller thickness, the glass film breaks more easily. As the glass film has a larger thickness, the glass film has less flexibility, resulting in difficulty in winding the glass film in a roll shape. Thus, the thickness of the glass film is preferably 5 to 100 μm, more preferably 10 to 100 Ξm. Further, as the plate glass having a thickness of more than 200 μm has a larger thickness, the effect of reducing and adjusting the variation of the flow rate of molten glass becomes larger. Thus, the thickness of the plate glass having a thickness of more than 200 μm is desirably 0.4 mm or more, preferably 0.5 mm or more, more preferably 0.6 mm or more.

According to the invention of claim 3, the molten glass flowing in each of the plurality of branched channels is imparted with flow resistance. Thus, the molten glass in the melting furnace can be prevented from flowing into each forming apparatus instantly without any resistance. Imparting flow resistance to the molten glass flowing in each of the branched channels can be attained by fitting a plurality of baffle plates for changing the flowing direction of the molten glass and for controlling the flow of the molten glass.

According to the invention of claim 4, the glass film is wound in a roll shape. Thus, it is possible to secure the cleanliness of the glass film, prevent the glass film from breaking, save space for storing the glass film, and improve the handleability of the glass film during its transportation. Further, according the invention of claim 1, a glass film having a less variation of the thickness or having less unevenness in the thickness can be obtained stably. Thus, an unnecessary stress is not applied to the glass film while and after the glass film is wound continuously, and the glass film can be prevented from breaking.

According to the invention of claim 5, the down-draw method is the overflow down-draw method or the slot down-draw method, and hence a glass film having a thickness of 1 to 200 μm can be effectively formed. In particular, in order to obtain a plate glass excellent in surface quality, the overflow down-draw method is more suitable than the slot down-draw method. Note that the overflow down-draw method is a method for manufacturing a glass plate by supplying molten glass to a trough which is made of a refractory, has a wedge shape in the cross section, and has a groove portion at the top portion, causing the molten glass to overflow from both sides of the groove portion at the top portion, causing the molten glass to fuse at the lower end portion thereof, to thereby form a plate-shaped glass ribbon, and subjecting the glass ribbon to down-draw in the vertical direction. On the other hand, the slot down-draw method is a method for manufacturing a glass plate by supplying molten glass to a trough having an elongated (slot-like) aperture portion, drawing the molten glass out from the aperture portion of the trough to form a plate-like glass ribbon, and subjecting the glass ribbon to down-draw in the vertical direction.

### BRIEF DESCRIPTION OF DRAWINGS

FIG. 1 is a partially broken schematic perspective view illustrating a molten glass supply system for carrying out a method for manufacturing a glass film of the present invention.

FIG. 2 is a vertical cross-sectional view illustrating a first forming apparatus.

FIG. 3 illustrates a vertical cross-sectional view common to second and third forming apparatuses.

### DESCRIPTION OF EMBODIMENT

An embodiment of the present invention is hereinafter described in detail with reference to the accompanying drawings.

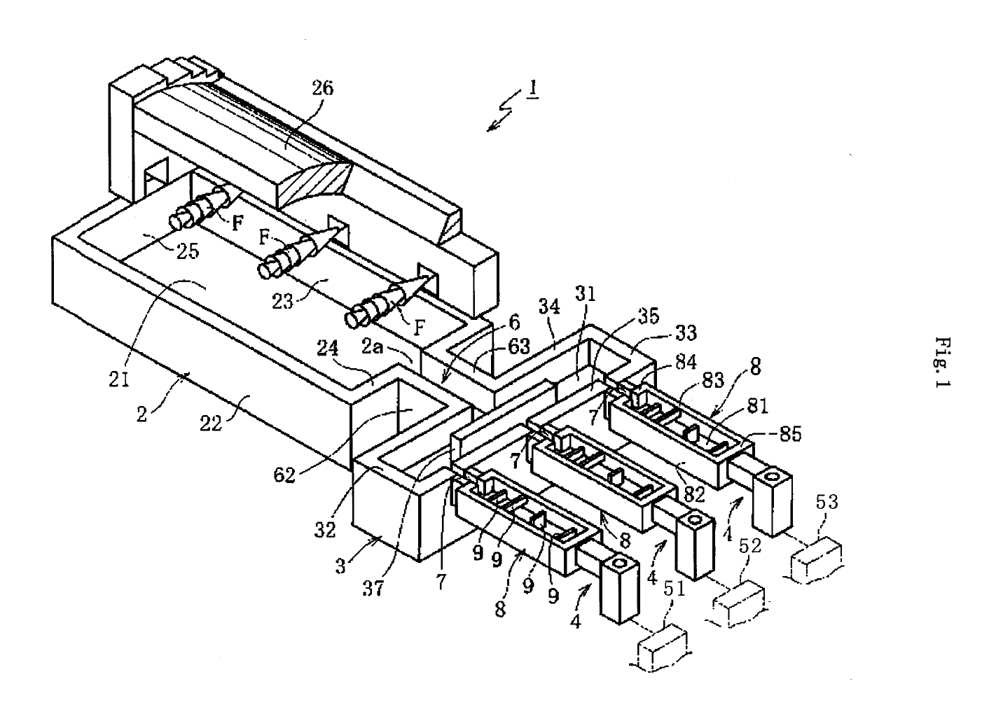

First, based on FIG. 1, the whole structure of a molten glass supply system according to the embodiment of the present invention is described. The molten glass supply system 1 includes one substantially rectangular melting furnace 2 serving as a supply source of molten glass, a distribution chamber (distribution part) 3 communicating with an outlet 2a of the melting furnace 2, and a plurality of branched channels 4 each communicating with an end portion in the downstream side of the distribution chamber 3 at substantially regular intervals. Those branched channels 4 each communicate, at the end portion in the downstream side, one of a plurality of forming apparatuses 51 to 53. Note that, though the figure illustrates three pathways to the forming apparatuses 51 to 53 via the branched channels 4, two pathways may be acceptable, or four or more pathways may be acceptable.

The melting furnace 2 includes a bottom wall 21, side walls 22 to 25, and an arch-shaped ceiling wall 26 entirely covering over the melting furnace 2. Those walls are each formed of a highly zirconia-based refractory (refractory brick), and flames F of a plurality of burners are shot from the upper portion of each of the left side walls and right side walls 22 and 23 toward the space above molten glass. Further, the molten glass filled in the melting furnace 2 is heated by the flames F of the burners from above the molten glass, thereby keeping the temperature of the molten glass at from 1,500 to 1,650° C.

The melting furnace 2 includes the outlet 2a in the central portion in the left-right direction of the side wall 24 in the downstream side. The melting furnace 2 communicates with the distribution chamber 3 via a narrow flow channel 6 having the outlet 2a at the upstream end. The distribution chamber 3 includes a bottom wall 31, side walls 32 to 35, and an arch-shaped ceiling wall (not shown) entirely covering over the distribution chamber 3. Those walls are each formed of a highly zirconia-based refractory (refractory brick). The temperature of molten glass in the distribution chamber 3 is kept at from 1,600° C. to 1,700° C.

The distribution chamber 3 has a smaller volume than the melting furnace 2 and is longer in the left-right direction. The downstream end of the flow channel 6 is open in the central portion in the left-right direction of the side wall 34 in the upstream side of the distribution chamber 3. A flow uniforming wall portion 37 being longer in the left-right direction is firmly provided in the central portion both in the front-back direction and the left-right direction of the distribution chamber 3 with flow spaces interposed between each of all the side walls 32 to 35 and the flow uniforming wall portion 37.

A plurality of small flow channels 7 are formed at substantially regular intervals in the side wall 35 located in the downstream side of the distribution chamber 3, and a plurality of flow resistance-imparting chambers (flow resistance-imparting portions) 8 are formed at the respective downstream ends of the small flow channels 7. Those flow resistance-imparting chambers 8 are longer in the front-back direction and have a smaller volume than the distribution chamber 3. In addition, each flow resistance-imparting chamber 8 includes surrounding walls 81 to 85 for forming a channel and a ceiling wall (not shown) entirely covering over the flow resistance-imparting chamber 8. Those walls are each formed of a highly zirconia-based refractory (refractory brick). The temperature of molten glass in the each flow resistance-imparting chamber 8 is kept at from 1,500° C. to 1,650° C.

In the each flow resistance-imparting chamber 8, a plurality of baffle plates for changing the flowing direction of molten glass internally flowing and for controlling the flow of the molten glass are provided in a row in the front-back direction at predetermined intervals. Those baffle plates 9 are used for imparting resistance to the molten glass flowing in the each flow resistance-imparting chamber 8, and the molten glass can be prevented from flowing instantly to the respective forming apparatus 51 to 53. Thus, the each flow resistance-imparting chamber 8 has a function of adjusting the respective supply pressure applied at the time when molten glass is separately supplied from the distribution portion 3 to each branched channel 4.

According to the molten glass supply system 1 having the above-mentioned configuration, the plurality of branched channels 4 communicate with the forming apparatuses 51 to 53 via the distribution chamber 3 from the melting furnace 2, and hence the molten glass in the melting furnace 2 is supplied to each of the forming apparatuses 51 to 53 through the respective branched channel 4. That is, carried out are a melting step of melting glass in the melting furnace 2, a distribution step of supplying the molten glass in the melting furnace 2 to the plurality of branched channels 4, and a forming step of supplying the molten glass flowing out of each of the plurality of branched channels 4 to one of the plurality of forming apparatuses 51 to 53 communicating with the branched channels 4, respectively, and forming the molten glass into a plate-shaped glass by a down-draw method.

Each of the forming apparatuses 51 to 53 is used to form molten glass into a plate-shaped glass (glass ribbon) by an overflow down-draw method. The first forming apparatus 51 is an apparatus for forming a glass film having a thickness of 1 to 200 μm. Both the second and third forming apparatuses 52 and 53 are apparatuses for forming a plate glass having a thickness of 0.7 mm.

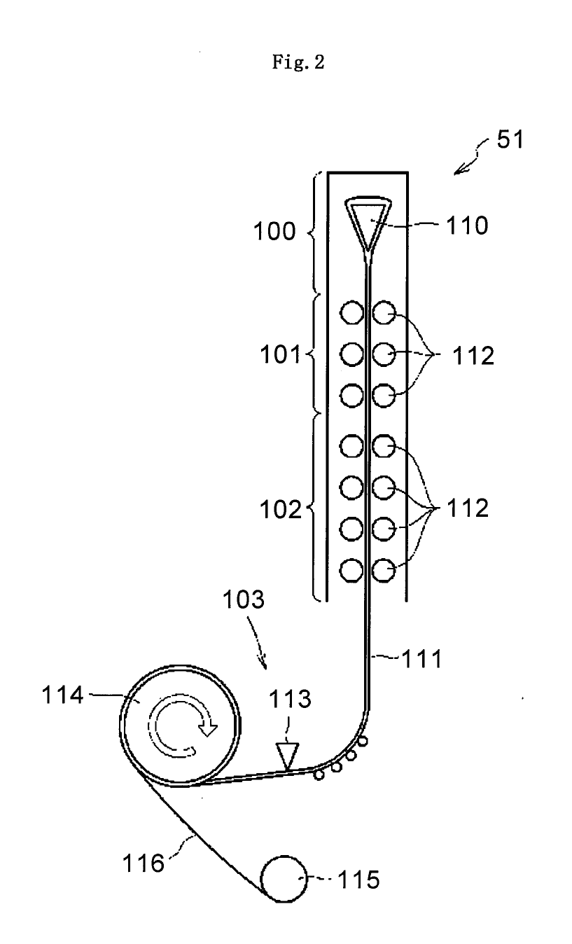

As illustrated in FIG. 2, the first forming apparatus 51 is provided with a forming zone 100, an annealing zone (annealer) 101, a cooling zone 102, and a processing zone 103 in the stated order from an upstream side.

In the forming zone 100, there is provided a trough 110 which is made of a refractory, has a wedge shape in the cross section, and has a groove portion at the top portion. Molten glass supplied to the trough 110 is caused to overflow from both sides of the groove portion at the top portion and is fused at the lower end portion thereof, to thereby form plate glass (glass ribbon). After that, the plate glass is drawn downward, thereby forming a glass film 111 from the molten glass. The thickness of the glass film is suitably adjusted depending on the flow rate of the molten glass and the rate of drawing the molten glass downward.

In the annealing zone 101, while annealing the glass film 111 with a heater for regulating temperature (not shown), the residual strain is removed (annealing process). In the cooling zone 102, the annealed glass film 111 is cooled sufficiently. In the annealing zone 101 and the cooling zone 102, a plurality of pulling rollers (annealing rollers) 112 for pulling the glass film 111 downward are arranged.

In the processing zone 103, ear portion-cutting means 113 for cutting (Y-cutting) the each end portion in the width direction of the glass film 111 (ear portion thickened relative to a center portion due to contact with the cooling rollers) along a conveying direction. The ear portion-cutting means 113 may form the scribe line with a diamond cutter, and may cut and remove the each end portion (ear portion) in the width direction along the scribe line by pulling the each end portion in the width direction of the glass film 111 outward in the width direction. However, in view of increasing strength of the end surface, it is preferred to cut and remove the ear portions of the glass film 111 by laser splitting.

Further, in the processing zone 103, a roll core 114 functioning as a winding roller is arranged. Around the roll core 114, the glass film 111 is wound, from which the each end portion (ear portion) in the width direction has been cut off. In this case, a protective sheet 116 is sequentially supplied from a protective sheet roll 115, and the protective sheet 116 is wound around the roll core 114 while being superposed on an outer surface side of the glass film 111. Specifically, the protective sheet 116 is pulled out of the protective sheet roll 115, the protective sheet 116 is superposed on the outer surface side of the glass film 111, and the glass film 111 and the protective sheet 116 are wound into a roll along a surface of the roll core 114. Then, after the glass film 111 is wound so as to have a predetermined roll outer diameter, only the glass film 111 is cut (X-cut) in the width direction by the cutting means (not shown). Then, after a trailing end of the cut glass film 111 is wound, only the protective sheet 116 is further wound one or more turns, and the protective sheet 116 is cut. Manufacturing of the glass roll is completed in a series of operations described above.

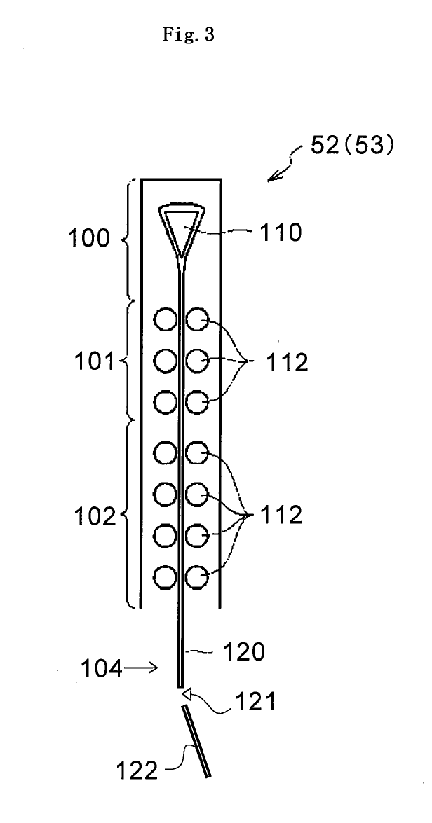

Further, as illustrated in FIG. 3, the second and third forming apparatuses 52 and 53 each includes a forming zone 100, an annealing zone 101, and a cooling zone 102 as the first forming apparatus 51 does. A processing zone 104 is provided with cutting means 121 for cutting (X-cutting), in the width direction, a plate glass (glass ribbon) 120 obtained after forming and annealing processes. The cutting means 121 has a function of drawing a scribe line on the glass ribbon 120 in the width direction and then snapping the glass ribbon 120. A plate glass 122 obtained by the snapping goes through the cutting and removal of its selvages and is then packaged.

The composition and characteristics of the molten glass which is used in the present invention are selected depending on intended used of the resultant plate glass. For example, when a glass substrate for a liquid crystal display is to be obtained, it is preferred to use alkali-free glass having a temperature corresponding to a viscosity of 1,000 dPa·s is 1,350° C. or more, preferably 1,420° C. or more and a strain point is 600° C. or more, preferably 630° C. or more. Further, when a plate glass is formed by an overflow down-draw method, if the liquidus viscosity of the glass is low, the plate glass is liable to denitrify, and hence the liquidus viscosity of the glass is 100,000 dPa·s or more, preferably 300,000 dPa·s or more, more preferably 500,000 dPa·s or more, most preferably 600,000 dPa·s or more.

Further, the composition of the glass includes, for example, in terms of mass %, preferably 40 to 70% of SiO₂, 6 to 25% of Al₂O₃, 5 to 20% of B₂O₃, 0 to 10% of MgO, 0 to 15% of CaO, 0 to 30% of BaO, 0 to 10% of SrO, 0 to 10% of ZnO, 0.1% or less of an alkali metal oxide, and 0 to 5% of a fining agent, more preferably 55 to 70% of SiO₂, 10 to 20% of Al₂O₃, 5 to 15% of B₂O₃, 0 to 5% of MgO, 0 to 10% of CaO, 0 to 15% of BaO, 0 to 10% of SrO, 0 to 5% of ZnO, 0.1% or less of an alkali metal oxide, and 0 to 3% of a fining agent.

Note that the present invention is not limited to the above-mentioned embodiment and can be embodied in other various modes as long as the modes do not deviate from the gist of the present invention.

In the above-mentioned embodiment, the case where the present invention was applied in manufacturing a glass film by the overflow down-draw method was described. In addition to this, the present invention can be applied in, for example, manufacturing a glass film by a slot down-draw method, in the same manner as that in the above-mentioned embodiment.

In the above-mentioned embodiment, there was described the case where the glass film was wound around the winding core in the state in which the protective sheet was superposed on the outer surface side of the glass film. Further, it is also possible to wind a glass film in the state in which a protective sheet is superposed on the inner surface side of the glass film.

### INDUSTRIAL APPLICABILITY

The method for manufacturing a glass plate of the present invention can be used for the production of glass plates for liquid crystal displays, and further, for the production of glass films which are used for: various flat panel displays such as a plasma display, an electroluminescence display including an OLED display, and a field emission display; solar cells; an OLED lighting device; and the like.

### REFERENCE SIGNS LIST

1 molten glass supply system
2 melting furnace
3 distribution chamber
4 branched channel
51, 52, 53 forming apparatus
6 flow channel
7 small flow channel
8 flow resistance-imparting chamber
9 baffle plate
100 forming zone
101 annealing zone
102 cooling zone
103, 104 processing zone
111 glass film
112 pulling roller
113 ear portion-cutting means
114 roll core
115 protective sheet roll
116 protective sheet
120 plate glass (glass ribbon)
121 cutting means
122 plate glass

1. A method for manufacturing a glass film, comprising:
a melting step of melting glass in a melting furnace;
a distribution step of supplying the molten glass in the melting furnace to a plurality of branched channels; and
a forming step of supplying the molten glass flowing out from each of the plurality of branched channels to each of a plurality of forming apparatuses communicating with the plurality of branched channels respectively, and forming the molten glass into a plate-shaped glass by a down-draw method,
wherein one or more of the plurality of forming apparatuses are used to form a glass film having a thickness of 1 to 200 μm.

2. The method for manufacturing a glass film according to claim 1, wherein a forming apparatus other than a forming apparatus for forming a glass film is used to form a plate glass having a thickness of more than 200 μm.

3. The method for manufacturing a glass film according to claim 1, wherein the molten glass flowing in each of the plurality of branched channels is imparted with flow resistance.

4. The method for manufacturing a glass film according to claim 1, wherein the glass film is wound in a roll shape.

5. The method for manufacturing a glass film according to claim 1, wherein the down-draw method comprises an overflow down-draw method or a slot down-draw method.

6. The method for manufacturing a glass film according to claim 2, wherein the molten glass flowing in each of the plurality of branched channels is imparted with flow resistance.

7. The method for manufacturing a glass film according to claim 2, wherein the glass film is wound in a roll shape.

8. The method for manufacturing a glass film according to claim 2, wherein the down-draw method comprises an overflow down-draw method or a slot down-draw method.
